(19) United States
(12) Patent Application Publication
(10) Pub. No.: US 2007/0250193 A1
(43) Pub. Date: Oct. 25, 2007

(54) Dongle-based multimedia player

(75) Inventors: Moshe Raines, Tel Aviv (IL); Dov Moran, Kfar Saba (IL); Avraham Meir, Rishon Lezion (IL); Eli Harari, Saratoga, CA (US); David Koren, Raanana (IL); Ran Carmeli, Rinatya (IL)

Correspondence Address: MARK M. FRIEDMAN, C/O DISCOVEY DISPATCH , 9003 FLIRIN WAY, UPPER MARLBORO, MD, 20772, US

(73) Assignee: SanDisk IL Ltd.

(21) Appl. No.: 11/710,988

(22) Filed: Feb. 27, 2007

Related U.S. Application Data
(60) Provisional application No. 60/745,195, filed on Apr. 20, 2006.
(60) Provisional application No. 60/747,194, filed on May 14, 2006.
(60) Provisional application No. 60/803,047, filed on May 24, 2006.
(60) Provisional application No. 60/746,653, filed on May 8, 2006.
(60) Provisional application No. 60/829,153, filed on Oct. 12, 2006.

(51) Int. Cl. G06F 17/00

(52) U.S. Cl. 700/94

(57) ABSTRACT

The present disclosure relates to a portable digital media player, and in particular to a portable digital media player device having specific mechanical properties. In some embodiments, the portable digital media player includes a device port that is configured as a supportive port. In some embodiments, the device port is a plug. In some embodiments, a volume ratio between a minimally circumscribing rectangular prism of the digital media player and a minimally circumscribing rectangular prism of the plug is at most 10:1, or at most 5:1. In some embodiments, a media system is provided where the digital media player is mated with the host presentation device. In some embodiments, the media system provides certain mechanical properties.

### CROSS-REFERENCE TO RELATED APPLICATIONS

This patent application claims the benefit of the following patent applications: U.S. Provisional Patent Application No. 60/745,195 filed Apr. 20, 2006, U.S. Provisional Patent Application No. 60/747,194 filed May 14, 2006, U.S. Provisional Patent Application No. 60/803,047 filed May 24, 2006; U.S. Provisional Patent Application No. 60/746,653 filed May 8, 2006; and U.S. Provisional Patent Application 60/829153 filed Oct. 12, 2006.

### FIELD OF THE INVENTION

The present invention relates to portable media player devices, and in particular, to portable media player devices having specific mechanical properties.

### BACKGROUND AND RELATED ART

### Portable Video Players

Portable video players, for example DVD video players, are well known in the art of entertainment equipment.

There is an ongoing trend of making portable video players smaller and less expensive, in order to enable users to spontaneously view video and/or listen to music wherever they encounter a television (TV) system.

Typically, multimedia players are packaged as self-contained devices that are supported (i.e. supported from falling) by being placed on a solid surface or by being held manually by a user, or by being plugged into a chassis. Known multimedia players are also provided with the electric power required for their operation using a power supply or batteries.

As electronic devices become smaller and more compact, the essential operational components—the storage and the conversion from digital to video format—become a very small part of the total package volume of the device. Typically, these components are smaller than the one of the batteries, and smaller than the plug of the power cord.

The power supply components, and the physical basis for stable standalone placement (that is not shaken by every move of the connecting cables and by each insertion and removal of the input and output cables), imply a package size that is much larger than the functional components require. It is not practical to design a supportive connector between a heavy player and a heavy TV, as the mass and inertia of both devices would create undesirable mechanical stress on the connectors.

### Portable Flash Storage Devices

Another type of device that is well-known is the USB flash drive such as the Cruzer® flash drive from SanDisk Corporation (Milpitas, Calif.). USB flash drives provide a convenient medium for the storage of user files and for the transfer of these files between different computers. USB flash drives are portable, lightweight external storage devices which can be mated or docked directly (i.e. without an intermediate external cable or cradle) with a user computer, and when docked to the user computer, are mechanically supported by the USB socket of the user computer. Typically, USB flash drives receive power from the host computer device via power pins of the USB plug. One salient feature provided by many USB flash drives is a relatively simplified user interface, which facilitates easy operation of the device.

It is quite common for users to store digital media files such as music files and/or video files on a USB flash drive. Whenever a user wishes to listen to music or view video of the digital media files, it is necessary for the user to obtain access to a computer having an onboard digital media playback module to playback the digital media files. However, there are many situations where a user does not necessarily have access to a computer with an onboard digital media playback module (or does not necessarily wish to use an available computer for multimedia playback), but nevertheless would like to view video media content, for example, on a television, video camcorder, home cinema system, digital video projector, or any other media presentation device.

It would be very useful and desirable to have a multimedia device (i.e. player or recorder device) that has a “key-chain device” form factor and/or has only a single port for receiving digital content and exporting one or more media stream(s) and/or does not require an independent power source and/or stably supports itself connected to the display device (i.e. is supported by the connection with the host device when docked to the host device). Furthermore, it would be useful to have a truly portable multimedia device that is not bulky and does not have significant weight.

### SUMMARY OF THE INVENTION

In accordance with some embodiments of the present invention, it is now disclosed a portable digital media player which includes a ‘supportive device port.’ When the ‘external’ portable media player is connected (i.e. either docked directly or coupled via a cradle or cable) with a host media presentation device (for example, a television set) via the supportive device port, the portable media player may (i) effect a playback of stored digital audio and/or video media to generate a video and/or audio stream; and (ii) export this media stream to the host media presentation device via the device port.

As used herein, when a portable electronic device (for example, a storage device or media player) includes a ‘supportive device port,’ the portable electronic device is mechanically supportable by a physical connection between the ‘supportive device port’ and a complementary port with which the ‘supportive device port’ is mated. Thus, such devices are sufficiently lightweight such that, when coupled to the complementary port, the complementary port mechanically supports the weight of the portable device.

One example of a ‘supportive device port’ is a supportive plug mechanically integrated with the device housing of the portable digital media player device. In this case, when the supportive plug is mated with a complementary socket, the complementary socket mechanically supports the weight of the portable device.

Another example of a ‘supportive device port’ is a supportive socket mechanically integrated with the device housing of the portable digital media player device. In this case, when the supportive socket is mated with a complementary plug, the complementary plug mechanically supports the weight of the portable device.

In some embodiments, the portable digital media player device provides a simplified interface and may lack one or more of (i) a viewing screen for displaying played-back video media content and/or (ii) a speaker for listening to played-back audio media content. Nevertheless, despite this lack of a viewing screen and/or audio speaker, the digital media player may nevertheless facilitate viewing and/or listening to the digital media content by exporting an audio and/or video stream to a host playback device which displays (i.e. visually and/or by means of an audio speaker) the exported stream received from the digital media player. In some embodiments, the portable digital media player may obviate the need for a presence of a computer (i.e. including digital media software and/or hardware) when viewing and/or listening to media content.

In accordance with some embodiments of the present invention, a portable digital media player device having a plug or male connector for exporting the video and/or audio stream to the host media presentation device is provided. Optionally, this plug or male connector is a so-called supportive plug.

In some embodiments, the portable digital media device (i.e. according to one or more size metrics defined below) has a size that is at most on the same order of magnitude (i.e. less than 20 times as large as, or less than 10 times as large as or less than 5 times as large as) as the device plug (for example, including but not limited to a USB plug) through which one or more media streams are exported. This may be useful for providing a portable media device for transport and playback of media content.

Another feature provided by some embodiments of the present invention is that docking of the portable digital media player to the host media presentation device serves to immobilize to a certain extent (i.e. as described below) the digital media player. This may, for example, be useful for providing a ‘tight’ mechanical coupling of the docked device to the housing of the host media presentation device.

In one example, docking of the digital media player to the host media presentation device serves to restrict rotational movement of the docked device—i.e. the housing of the docked digital media player device may not be rotated beyond a certain tolerance angle without decoupling the digital media player device from the host media presentation device. Alternatively or additionally, docking of the digital media device services to restrict translational motion (i.e. without decoupling the docked media player device from the host media presentation device)—either along a so-called docked device vector and/or in a direction perpendicular to the docked device vector.

It is now disclosed for the first time a digital media player device comprising: a) a digital media player housing; b) a digital playback module housed by the housing the digital playback module operative to effect a media playback of stored digital media to generate at least one output media stream selected from the group consisting of an audio output stream and a video output stream; and c) a device port selected from the group consisting of a plug and a socket, mechanically integrated with the playback device housing and operative to output at least one output media stream to a host media presentation device, wherein the digital media player device is configured such that the device port is a supportive port.

According to some embodiments, the device port is the plug (including but not limited to a USB plug), and the plug is a supportive plug.

According to some embodiments, the supportive plug is supportive when a docked device vector is in a substantially horizontal orientation within a tolerance angle that is at most 30 degrees (or at most 10 degrees).

According to some embodiments: i) the digital playback module is operative to effect a video playback of stored video digital media to generate the video stream; and ii) the device port is operative to export the video stream.

According to some embodiments, at least one output media stream is an analog media stream.

According to some embodiments, at least one output media stream is a digital media stream.

According to some embodiments, the device port is operative to receive electric power from the host media presentation device.

According to some embodiments, a power-dependence of the digital media player on the received electrical power via the device port is complete (i.e. because the media player lacks a power storage such as an internal battery, and must receive electrical power via the device power from the host).

According to some embodiments, the digital media player device lacks a display screen operative to display played back digital media.

According to some embodiments, the digital media player device lacks a speaker operative to present played back audio media.

According to some embodiments, the digital media player lacks a camera and/or microphone.

According to some embodiments, the digital media player further includes: c) an onboard non-volatile flash memory housed by the housing (i.e. within the housing and/or mounted on the housing) for storing the stored digital media.

According to some embodiments, the digital media player further includes: c) at least one memory card slot for interface with a memory card on which the stored digital media resides.

According to some embodiments, at least one memory card slot is adapted to interface with a the memory card selected from the group consisting of a memory stick, an SD card, an MultiMediaCard (MMC) and a transflash card.

According to some embodiments, i) the device port is further operative to receive at least one input media stream selected from the group consisting of a video input media stream and an audio input media stream, and ii) the digital media player device further comprises: c) a digital media recording module operative to record at least one received input media stream to generate at least one of stored digital audio media and stored digital video media, wherein the digital media player device is operative such that when the output port is mated with a complementary port, the digital media player is supportable by a physical connection between the output port and the complementary port.

According to some embodiments, the digital media player device is operative to accept at least one media playback command and to effect the media playback in accordance with the accepted at least one media playback command.

According to some embodiments, the digital media player further includes c) a command data port for receiving the at least one media playback command.

According to some embodiments, the digital media player further includes: c) a mechanical user command input (for example, buttons, a pressure or movement-sensor ‘joystick’).

According to some embodiments, the digital media player including the supportive plug is configured such that the supportive plug has a support factor that is at least 1.5 (i.e. the supportive plug can support 1.5 times the weight of the digital media player).

According to some embodiments, the digital media player device is operative to export to the host presentation device a menu video signal (for example, a video signal indicative of a list of content items stored in the digital media player device or on a memory card coupled to the digital media player device—this exported video signal may be displayed by the host media presentation device and may be useful for selecting a content item).

It is now disclosed for the first time a media playback system comprising: a) a digital media player device including: i) a digital media player housing; and ii) a device port mechanically integrated with the digital media player housing; b) a host media presentation device including: i) a host device housing; and ii) a host port mechanically integrated with the host device housing, the host port being complementary to the device port; wherein: i) the device port is mated with the host port; and ii) the digital media player is operative to effect a playback of stored digital media and to export to the host media presentation device, via the device and host ports, at least one media stream selected from the group consisting of a video stream and an audio stream. Thus, according to these particular embodiments, a system where the media player device is coupled ‘directly’ with the host presentation device, without any need for an intermediate external cable or cradle, is provided.

According to some embodiments, i) the digital media player device and the host media presentation device are connected such that a docked device vector cannot be rotated by more than 45 degrees without decoupling the digital media player device from the host media presentation device; and ii) a value of the angle tolerance parameter is at most 45 degrees.

According to some embodiments, the value of the rotation tolerance parameter is at most 23 degrees.

According to some embodiments, i) the digital media player device and the host media presentation device are connected such that a center of the digital media player device cannot be moved by more than a docked device tolerance distance without decoupling the digital media player device from the host media presentation device; ii) a value of the docked device tolerance distance is at most a multiple of a maximum dimension of a minimally circumscribing rectangular prism of an inserted plug region of the mated device and host ports; iii) a value of the multiple is at most 1.

According to some embodiments, the value of the multiple is at most 0.5 (or at most 0.25).

According to some embodiments, the host presentation device is selected from the group consisting of a TV set, a digital video camcorder, a digital video projector and a home cinema system.

It is now disclosed for the first time a media playback system comprising: a) a digital media player device including: i) a digital media player housing; and ii) a device port mechanically integrated with the digital media player housing; b) a host media presentation device including: i) a host device housing; and ii) a host port mechanically integrated with the host device digital media player housing c) at least one external connector selected from the group consisting of an external cable and a cradle, wherein the system is configured such that: i) the digital media player device is connected to the host device via the device port, the at least one external connector and the host port; ii) the digital media player is operative to effect a playback of stored digital media and to export to the host media presentation device, via the device port, the at least one connector and the host port at least one media stream selected from the group consisting of a video stream and an audio stream; iii) the host port supports the combination of the host media presentation device and the at least one connector. Thus, according to these particular embodiments, a system where the host device supports both the digital media player as well as the connective external cable(s) and/or cradle(s) is provided.

According to some embodiments, the system is configured such that the host port and the at least one external connector stably maintain an orientation of a docked device vector of the system stable when the docked device vector is substantially perpendicular to a gravity vector within a tolerance of 23 degrees.

It is now disclosed for the first time a digital media player device for use with a host media presentation device, the media playback device comprising: a) a digital media player housing; b) a digital playback module housed by the housing, the digital playback module operative to effect a media playback of stored digital media to generate at least one of media stream selected from the group consisting of an audio stream and a video stream; and c) an output plug mechanically integrated with the digital media player housing, the output plug for exporting at least one media stream to the host media presentation device.

According to some embodiments, a volume ratio between the: i) a minimally circumscribing rectangular prism of the digital media player (i.e. including the plug); and ii) a minimally circumscribing rectangular prism of the output plug (i.e. the region that is inserted within the standard complementary socket) is at most 10:1 (or at most 5:1).

These and further embodiments will be apparent from the detailed description and examples that follow.

### BRIEF DESCRIPTION OF THE DRAWINGS

FIGS. 1A-1D provide diagrams of a media playback system including a host presentation device and a portable media player, according to some embodiments of the present invention.

FIG. 2 provides a diagram of a portable media player according to some embodiments of the present invention.

While the invention is described herein by way of example for several embodiments and illustrative drawings, those skilled in the art will recognize that the invention is not limited to the embodiments or drawings described. It should be understood that the drawings and detailed description thereto are not intended to limit the invention to the particular form disclosed, but on the contrary, the invention is to cover all modifications, equivalents and alternatives falling within the spirit and scope of the present invention. As used throughout this application, the word “may” is used in a permissive sense (i.e., meaning “having the potential to’), rather than the mandatory sense (i.e. meaning “must”).

### DETAILED DESCRIPTION OF EMBODIMENTS

The present invention will now be described in terms of specific, example embodiments. It is to be understood that the invention is not limited to the example embodiments disclosed. It should also be understood that not every feature of the presently disclosed display device, storage device, and methods of operating the same is necessary to implement the invention as claimed in any particular one of the appended claims. Various elements and features of devices are described to fully enable the invention. It should also be understood that throughout this disclosure, where a process or method is shown or described, the steps of the method may be performed in any order or simultaneously, unless it is clear from the context that one step depends on another being performed first.

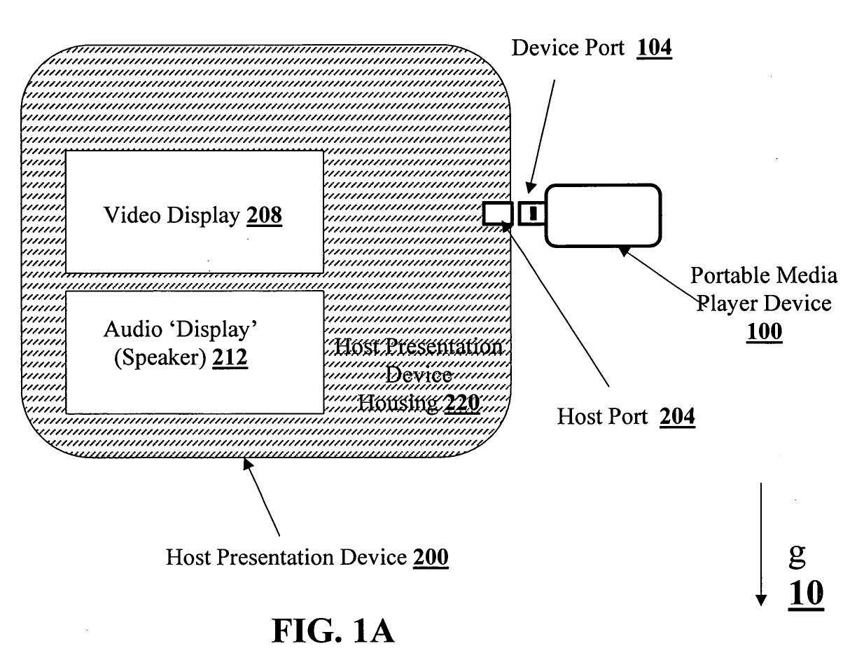

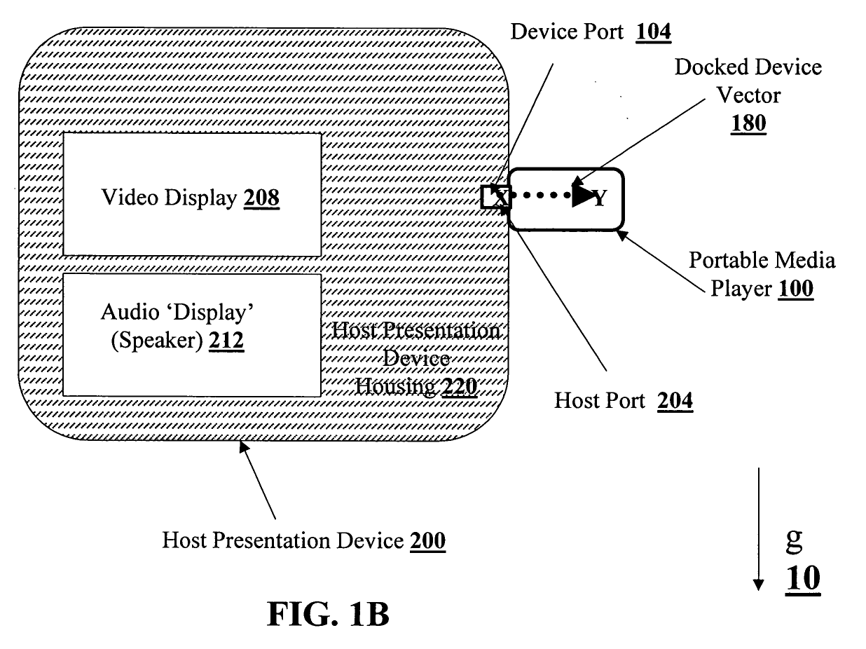

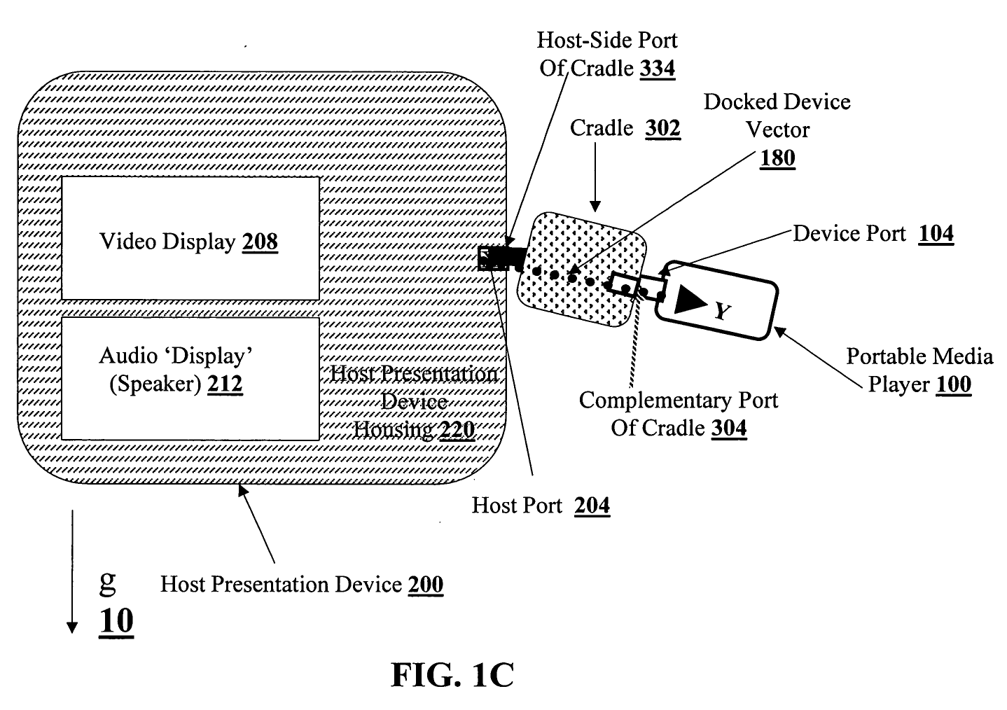

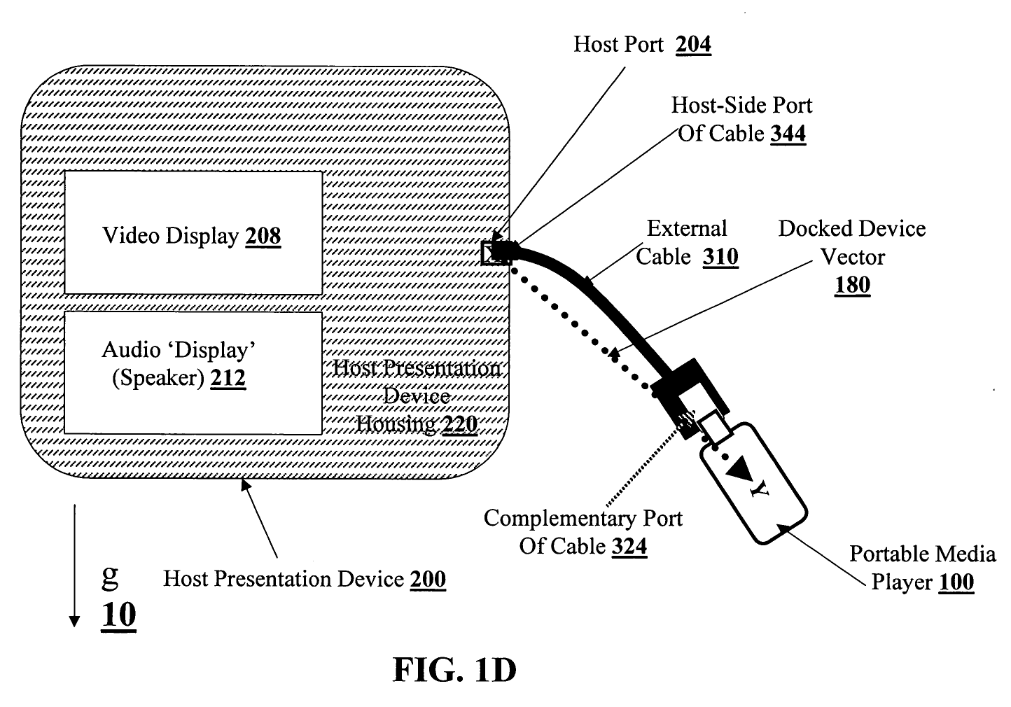

FIGS. 1A-1D provide diagrams of an exemplary portable media player device 100 or ‘dongle’ device, having at least one device port 104, that is docked to a host media presentation device 200 (for example, a television) having at least one host port 204.

When portable media player 100 is docked to the host display device 220, the media player 100 is also ‘operatively coupled’ to the host display device 220, so that (i) portable media player 100 may effect a media playback of stored digital media and ‘export’ a video and/or audio media stream to host display device 200 via respective ports 104 and 204 and optionally (ii) portable media player 100 may record one or more media streams (i.e. to produce stored digital media). Thus, portable media player 100 is a device having media playback capabilities and optionally recording capabilities to record a media stream received from host media presentation device 200 via respective ports 204 and 104. Ports 204 and 104 are compatible or ‘complementary’ ports that are appropriately shaped and dimensioned for mating with each other.

In one embodiment, both port 104 and the complementary port are dimensioned according to a known port standard (i.e. for sockets and plugs), for example, including but not limited to the USB standard.

As used herein, when digital media player device 100 and host media presentation device 200 are ‘operatively coupled,’ this means that player 100 and host 100 are physically connected or fastened to each other either (i) directly (i.e. where a plug 104 of device 100 is mated with a socket 204 of host 200, or where a plug 204 of host 200 is mated with a socket 104 of device 100) or (ii) via an intermediate object such as a cradle and/or a cable. When player 100 is ‘operatively coupled’ with host 200, they are configured such that a media stream signal may be exported from the player 100 to the host 200 and/or from host 200 to player 100.

As illustrated in FIGS. 1A-1D, the media presentation device includes at least one of: a video display 208 (i.e. a display screen) for displaying a video stream exported by and received from portable media player 100 (i.e. received via device ports 104 and 204) and a speaker for ‘presenting’ an audio stream exported by and received from portable media player 100.

As used herein, a ‘media presentation device’ comprises: (i) a housing 220, (ii) a host port 204 (i.e. socket or plug that is mechanically integrated with housing 220) dimensioned, for example, to accommodate a plug or socket 104 of digital media playback device 100 (or a cable or cradle) and operative to receiving a media (i.e. video and/or audio) stream and to optionally export a media stream; and (iii) a video 208 and/or audio 212 presentation device for presenting the received video and/or audio stream.

Typically, the host media presentation device is larger, and possible much larger than the digital media device player.

The ‘media stream’ may be an analog signal such as the video or audio signals received on ordinary television sets (i.e. via so-called banana cables) or received via an S-video socket. In yet another embodiment, the media stream is a digital signal, for example, uncompressed digital media signal, for example, using the HDMI standard.

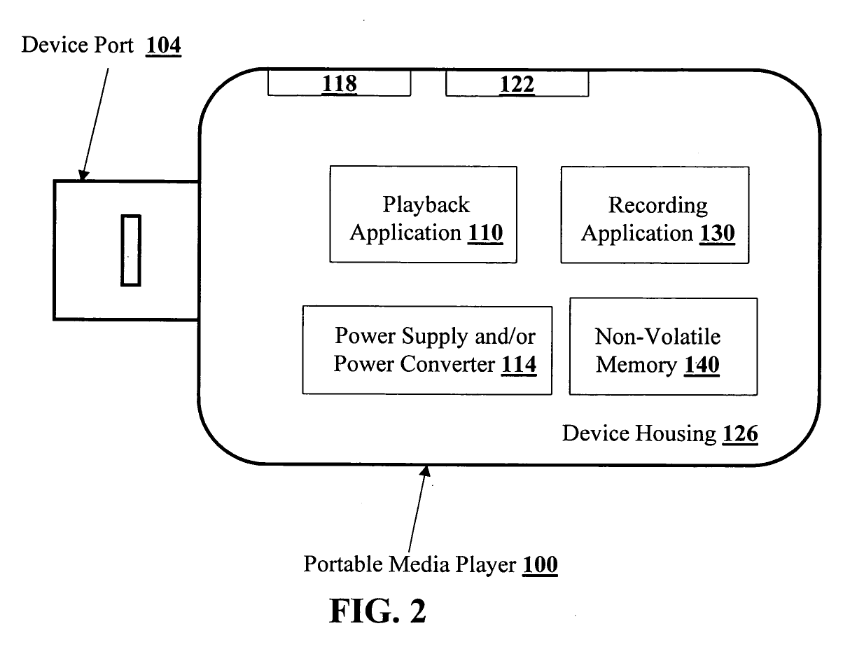

In the example of FIGS. 1A-1D, FIG. 2, the portable media player 100 is configured as an ‘external’ portable media player 100—i.e. portable media player 100 is reversibly docked to an external surface of host display housing 220 and resides in a device housing 126 that is different from host display housing 220. Furthermore, in the specific example of FIG. 1, host port 204 resides on the solid face of the host media presentation device 200 and portable media player 100 is thus docked to a convex surface of housing 220. Alternatively, in some embodiments, the ‘external’ portable media player 100 is reversibly docked to a region of a surface of host display device housing 220 that is concave. As used herein, an ‘external’ portable media player 100 may dock with a host port 204 that is integrally formed with host display housing 220—for example, embedded within the host display housing 220 (for the case where host port 204 is a female port—for example, a female USB TV port) or protruding from host display housing (for the case where host port 204 is a male port).

Attention is now called to FIG. 1B. It is noted that the force of gravity acts upon the portable media player device 100, and gravity vector 10 is depicted in FIG. 1B. Nevertheless, the portable media player 100 is mechanically held to host presentation device housing 220 via device port 104 that is mechanically integrated with host presentation device housing 220.

Because the digital media player device 100 is configured such that device port 104 is a ‘supportive plug,’ when device port 104 is mated with the complementary port 204, and when complementary host port 204 is held still, digital media player device 100 is also stably held in place by the complementary port 204. Thus, complementary port 204 bears the weight of digital media player device 100 via a connection with ‘supportive port’ 104.

The aforementioned ‘supportive plug’ (for example, a multi-pin plug) is just one example of a supportive device port. Alternatively, the supportive device port is a supportive socket (for example, a multi-pin socket) that is mechanically integrated with digital media player device housing 126. In this case, the supportive socket of digital media player device 100 is mated with a complementary plug (for example, mechanically integrated with housing 220 of host 200, or a complementary plug of an external cable or cradle), and when the complementary plug is held still, forces between the complementary plug and the socket of digital media player device hold digital media player device 100 in place despite the gravitational forces or torques on digital media player device 100.

Thus, in embodiments where the playback device 100 includes a ‘supportive plug’ the device 100 is mechanically supportable by a compatible or complementary socket of host device 200 when playback device 100 is rigidly or semi-rigidly (for example, a hinged connection) docked to housing 220 of host presentation device 200. In embodiments where the playback device 100 includes a ‘supportive socket’ the device 100 is mechanically supportable by a compatible or complementary plug of host device 200 when playback device 100 is rigidly or semi-rigidly (for example, a hinged connection) docked to housing 220 of host presentation device 200.

In the example of FIG. 1B, the media player device is solely supported by a connection between device port 104 and complementary port 204, without any need for external support to portable media player device 100.

In the example of FIG. 1B, digital media player device 100 is ‘directly’ coupled to presentation device 200 (i.e. not via an external cable or cradle), and the complementary port 204 mated to device port 104 is held still by forces between complementary port 204 and the host presentation device housing 220 (i.e. because complementary port 204 is mechanically integrated with presentation device housing 220). Thus, in FIG. 1B portable media device 100 is supported by device port 104, which, in turn, is held by the host port 204.

In alternative embodiments, as illustrated in FIGS. 1C-1D, device port 104 is held still by the complementary port 304 of the cradle 302 or the complementary port 324 of the external cable 310. Each complementary port (i.e. 304 or 324) is mated with device port 104, and served to hold device port 104 still. In both FIGS. 1C and 1D, device port 104 is said to support portable media player 100, and is said to be a supportive port of media player 100.

Thus, it is noted that the above definition of ‘supportive plug’ referred to a specific example of a complementary port mated to device port 104—i.e. complementary host port 204. This is not a limitation, and the complementary port may be, for example, a complementary port 304 of a cradle 302 or a complementary port 326 of external cable 310 as illustrated in FIGS. 1C and 1D.

### Docked Device Vector

In the example of FIGS. 1B-1D, docked device vector 180 is also illustrated. In the example of FIG. 1B, the tail of docked device vector 180 is the center of a ‘inserted plug region’ of socket 104 of host device 200. The head of docked device vector 180 is a center of the digital media player device (i.e. including device port 104)—for example, a center of mass or a center of a minimally circumscribing rectangular prism.

As used herein, the “minimally circumscribing” rectangular prism refers to the circumscribing rectangular prim with the minimal volume.

The docked device vector tail is defined as follows. If device port 104 is a plug as in FIG. 1B (or the host-side port of a cable or cradle 334 or 344 as in FIGS. 1C-1D), and complementary port 204 of the host display housing 220 (or of a cable or cradle) is a socket, the tail of the docked device vector is the center of the volume that is the ‘inside’ of the socket into which a portion of the plug 104 is inserted. If device port 104 is a socket (or the host-side port of a cable or cradle 334 or 344), the docked device vector tail is the center of volume of the portion of complementary plug (i.e. of the host device or of a cable or cradle) that, upon mating, is located within the device port 104 socket.

The docked device vector head is defined as the center (for example, a center of mass or a center of a minimally circumscribing rectangular prim) of portable media player device 100 (i.e. including device port 104. The aforementioned definitions of the docked device vector tail and head serve to define the docked device vector.

In the example of FIG. 1B, the entirety of the docked device vector is located within the housing of portable media player 100. In exemplary embodiments, the portable media player 100 is held to the host display housing 220 such that at least a majority (or a substantial majority that is at least 75%) of the line segment defined by docked device vector is within the housing 126 of portable media player 100.

An additional feature illustrated in FIG. 1B is the orientation of the docked device vector is substantially horizontal—i.e. the docked device vector is substantially perpendicular (within a tolerance of, for example, 20 degrees or 10 degrees) to gravity vector 10.

It is noted that in certain embodiments, including but not limited to embodiments where device port 104 is a USB plug or socket, docking of media playback device 100 to host 200 may restrict certain degrees of freedom of media playback device 100 while docked to the host 200.

In one example, the rotational freedom may be restricted. Thus, in some embodiments, the digital media player device 100 is docked to the host device 200 such that the docked device vector (i.e. whose direction is determined by a location of a center of playback device 100) may not rotate (for example, by more than 45 degrees or more than 23 degrees) without decoupling media player device 100 from host device 200.

In another example, translational freedom may be restricted. Thus, in some embodiments, the center of media playback device 100 cannot be moved by more than a given distance (for example, a maximum dimension of a minimally circumscribing rectangular prism of an inserted plug region of the mated device 104 and host 204 ports, or half this distance, or a quarter of this distance) without decoupling media player device 100 from host device 200.

### Playback Features

FIG. 2 illustrated an exemplary digital media player device 100 in accordance with exemplary embodiments of the present invention. The device includes playback module 110 which may be implemented as any combination of hardware, electronic circuitry and firmware. In one example, the playback module 110 includes computer code executed by a CPU (not shown) using volatile memory (not shown) for storing software variables. As used herein, if the digital playback module is “housed by” device housing, this refers to the case where: i) the aforementioned computer code resides in volatile and/or non-volatile memory that is within or mounted on the housing; ii) the aforementioned electronic circuitry is within or mounted on the housing.

The playback module 110 is operative to export a stream via device port 104 to the host 200. Thus, in exemplary embodiment, the device port 104 includes video and/or audio pins connected to the playback module 110. Optionally, in one preferable embodiment, portable media player 100 may receive power from host 200, and thus, device port 104 may include power pins connected to power converter module 114. Alternatively, the device includes an onboard power supply 114.

In some embodiments the digital media player device 100 includes a non-volatile flash memory 140 for storing stored digital media content. Alternatively or additionally, the digital media player device 126 the stored digital media content is stored on a separate memory stick or memory card (for example, an SD card or TransFlash/microSD card). As used herein, ‘TransFlash’ is a commercial name for a well known portable storage card available from SanDisk Corporation (Milpitas, Calif.). A ‘MS’ or ‘Memory Stick’ is a commercial name of a well known portable storage device available from Sony Corporation, Tokyo, Japan.

In the example of FIG. 2, the digital media player device thus includes a slot or socket (118 or 120) for accommodating ‘external storage’ such as a SD card, MS storage, TransFlash or microSD storage or any other storage.

Management of the internal non-volatile flash storage 140 and/or external storage (i.e. (e.g. for example, an external memory card or memory stick) may be performed by a controller (not shown) for example, similar to controllers found in cameras and MP3 players,(such as HP PhotoSmart R927 available from HP, see also http://www.cameras2u.com/products/details.cfm?product=HEWPSR927).

In some embodiments, device 100 includes a CODEC (not shown) (such as Vaddis 888, available from Zoran, see also http://www.zoran.com/Vaddis-R-888) which is used by (or part of) playback module 110 and/or recording module 130. In playback mode, the digital multimedia content stored on either the internal storage or the external storage connected via sockets 120 and/or 118, and transfers it to the CODEC. The CODEC translates the digital stream into viewable Audio/Video signals (i.e. media streams) fed into the appropriate pins of device port 104, for displaying on the presentation host device 200.

In some embodiments, playback module 110 (for example, using the CODEC) decodes the stored digital media and generates a decoded media stream (i.e. which may be exported via device port 104). According to these embodiments, there is no requirement for the host presentation device 200 to provide decoding capabilities.

Similarly, in some embodiments, recording module 110 (for example, using the CODEC) may encode a received media stream.

### Loading Digital Media Onto the Device from a Personal Computer

In some embodiments, it may be desirable to load digital media onto the device via device port 104. Thus, in one example, device port 104 is a USB plug which supports the USB standard. Thus, the device 100 may be mated with a personal computer as well as the host media presentation device 100. In one example, first digital media is loaded from the computer to the media playback device (and stored, for example, in non-volatile flash memory 140), and then played back when the digital media player device 100 is docked to the host presentation device 200. Thus, in exemplary embodiments, media playback device 100 is able to ‘recognize’ (for example, by recognizing electrical signals or through some mechanical switch) if it is coupled to the computer or to the host media presentation device 200 and behave accordingly.

Thus, in some embodiments, device port 104 is a so-called ‘dual mode digital multimedia connector’ as described in United States U.S. Provisional Patent Application 60/747,194. Thus, in some embodiments, media player 100 is able to recognize a host device type—for example, to determine whether the host device is (i) a presentation device 200 or (ii) a ‘computer’ host (for example, a laptop or desktop) operative to upload one or more files to the digital media player 100.

Thus, in some embodiments, media player 100 includes a ‘host-type recognition element’ (not shown) for example, residing at least in part within device port 104. The host-type recognition element may include any combination of electronics, mechanical elements, and software. Thus in some embodiments, the media player 100 selects a data communication protocol (for example, effect a decision to communicate using a USB protocol or to export a media stream) in response to a detected host-device type.

In some embodiments, the host-type recognition element may be at least in part mechanical, for example, including a switch whose configuration is determined by a geometry of host-side port. According to this example, the device port 104 is dimensioned to mate with a host-side port of either host-device type; nevertheless, the actual shape of the host-side ports of the different devices differs so that, upon mating with device port 104, a switch associated with device port 104 adopts a first configuration for the case of the first host type, and a second configuration for the case of the second host type.

Alternatively or additionally, in another example, the host-type recognition element may recognize a voltage or status of a pin of a host-side port.

In some embodiments, the device includes only a single port 104 (i.e. the device lacks sockets or slots for memory cards or memory sticks or other external storage) through which: I) digital media content is received from a personal computer and II) a media stream is exported for presentation on host presentation device 200. Nevertheless, this is not a requirement, as illustrated in FIG. 2.

In some embodiments, in order to provide a more simplified device and/or interface, the device lacks certain elements, such as a screen for viewing played back content, a speaker for listening to playback content, a microphone for recording sounds, and a camera.

### User Control of Playback Device 100/Media Playback Commands

The operation of the player can be controlled by a user using one or more of the following:

1) Buttons or other mechanical controls provided on the device 100;

2) A remote control, as described in United States U.S. Provisional Patent Application 60/746,653. Thus, in some examples, the portable media playback device is operative to receive user-generated commands from a remote control via a wireless link.

3) A joy stick functionality of the dongle, as described in United States U.S. Provisional Patent Application 60/803,047. Thus, in some embodiments, the portable media playback device includes one or more mechanical sensors residing on a housing of the portable media playback device for sensing a force or stress on the housing of the portable media playback device. One or more media playback commands may be provided in response to the sensed forces, thereby allowing a user to control operation of the player by providing force on the coupled media playback device.

It is appreciated that the aforementioned list includes examples of user controls and is not intended as a comprehensive list.

These aforementioned user controllers may be used for inputting to the device ‘media playback commands’ including but not limited to ‘play’; ‘stop’; ‘pause’; ‘next track’; ‘select item’, etc.

Feedback for controlling the player can be provided to the user on the display of the hosting device, as described in United States U.S. Provisional Patent Application 60/745,195. Thus, in some embodiments, the portable media player playback device is operative to generate a ‘menu’ video signal listing one or more content items stored on the device or on a memory stick (or memory card) connected to the external storage device.

### Additional Remarks

In some embodiments, the digital media player may be operative to receive electrical power from the host presentation device. In some embodiments, the digital media player is ‘completely dependent’ on the host for electrical power, and lacks an electrical power storage (for example, a disposable or re-chargable power).

Embodiments of the present invention thus enable a user to download multimedia content into a portable external device, to carry this device in his pocket, and to use the device for playing and controlling the downloaded multimedia content on different compatible viewing devices. In various embodiments, playback device 104 can receive content either by downloading the content from a computer or by plugging into the device a small memory card that contains the content. Such memory cards can get their content either by downloading it from a digital storage device via a computer, or from a network via a computer, or from a recording device such as a digital camcorder.

In one example, playback device 104 is free of controls, displays and power supply circuitry, can consume less than 30 cubic centimeters of space and fit a key-chain or a small pocket.

In one example, playback device 104 is free of controls, displays, and power supply circuitry, can weigh less than 100 grams, and support itself on a standard USB connector without applying excessive force on the structure of the socket. It is noted that the ‘lightweight’ property may be useful, in combination with the mechanical properties of device port 104, to provide a playback device that can be supported by a compatible port mated with the device port 104.

It should be clear that the present invention covers any playing system where the dongle and the display are equipped with supportive multi functional connectors, even if the dongle is connected to the display via an interfacing cable that does not exercise the mechanical functionality of the supportive connectors.

In the description and claims of the present application, each of the verbs, “comprise” “include” and “have”, and conjugates thereof, are used to indicate that the object or objects of the verb are not necessarily a complete listing of members, components, elements or parts of the subject or subjects of the verb.

All references cited herein are incorporated by reference in their entirety. Citation of a reference does not constitute an admission that the reference is prior art.

The articles “a” and “an” are used herein to refer to one or to more than one (i.e., to at least one) of the grammatical object of the article. By way of example, “an element” means one element or more than one element.

The term “including” is used herein to mean, and is used interchangeably with, the phrase “including but not limited” to.

The term “or” is used herein to mean, and is used interchangeably with, the term “and/or,” unless context clearly indicates otherwise.

The term “such as” is used herein to mean, and is used interchangeably, with the phrase “such as but not limited to”.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art.

What is claimed is:

1) A digital media player device comprising:
a) a digital media player housing;
b) a digital playback module housed by said housing, said digital playback module operative to effect a media playback of stored digital media
to generate at least one output media stream selected from the group consisting of an audio output stream and a video output stream; and
c) a device port selected from the group consisting of a plug and a socket, mechanically integrated with said playback device housing and operative to output at least one said output media stream to a host media presentation device,
wherein the digital media player device is configured such that said device port is a supportive port.

2) The digital media player of claim 1 wherein said device port is said plug, and said plug is a supportive plug.

3) The digital media player of claim 1 wherein said plug is a USB plug.

4) The digital media player of claim 1 wherein said supportive plug is supportive when a docked device vector is in a substantially horizontal orientation within a tolerance angle that is at most 30 degrees.

5) The digital media player of claim 4 wherein said tolerance angle is at most 10 degrees.

6) The digital media player of claim 1 wherein:
i) said digital playback module is operative to effect a video playback of stored video digital media to generate said video stream; and
ii) said device port is operative to export said video stream.

7) The digital media player of claim 1 wherein at least one said output media stream is an analog media stream.

8) The digital media player of claim 1 wherein at least one said output media stream is a digital media stream.

9) The digital media player of claim 1 wherein said device port is operative to receive electric power from said host media presentation device

10) The digital media player of claim 9 wherein a power-dependence of the digital media player on said electrical power received via said device port is complete.

11) The digital media player of claim 1 wherein the digital media player device lacks a display screen operative to display played back digital media.

12) The digital media player of claim 1 wherein the digital media player device lacks a speaker operative to present played back audio media.

13) The digital media player of claim 1 wherein the digital media player lacks a camera.

14) The digital media player of claim 1 wherein the digital media player lacks a microphone.

15) The digital media player of claim 1 further comprising:
c) an onboard flash memory housed by said housing for storing said stored digital media.

16) The digital media player of claim 1 further comprising:
c) at least one memory card slot for interface with a memory card on which said stored digital media resides.

17) The digital media player of claim 16 wherein at least one said memory card slot is adapted to interface with a said memory card selected from the group consisting of a memory stick, an SD card, an MultiMediaCard (MMC) and a microSD card.

18) The digital media player device of claim 1 wherein:
i) said device port is further operative to receive at least one input media stream selected from the group consisting of a video input media stream and an audio input media stream,
ii) the digital media player device further comprises:
c) a digital media recording module operative to record at least one said received input media stream to generate at least one of stored digital audio media and stored digital video media,
wherein the digital media player device is operative such that when said output port is mated with a complementary port, the digital media player is supportable by a physical connection between said output port and said complementary port.

19) The digital media player device of claim 1 wherein the digital media player device is operative to accept at least one media playback command and to effect said media playback in accordance with said accepted at least one media playback command.

20) The digital media player device of claim 19 further comprising:
c) a command data port for receiving said at least one media playback command.

21) The digital media player of claim 19 further comprising:
c) a mechanical user command input.

22) The digital media player of claim 1 wherein the digital media player device is configured such that said supportive device port has a support factor that is at least 1.5.

23) The digital media player of claim 1 wherein the digital media player device is operative to export, via said device port, to said host presentation device a menu video signal.

24) A media playback system comprising:
a) a digital media player device including:
i) a digital media player housing; and
ii) a device port mechanically integrated with said digital media player housing;
b) a host media presentation device including:
i) a host device housing; and
ii) a host port mechanically integrated with said host device housing, said host port being complementary to said device port;
wherein:
i) said device port is mated with said host port; and
ii) said digital media player is operative to effect a playback of stored digital media and to export to said host media presentation device, via said device and host ports, at least one media stream selected from the group consisting of a video stream and an audio stream.

25) The media playback system of claim 24 wherein:
i) said digital media player device and said host media presentation device are connected such that a docked device vector cannot be rotated by more than 45 degrees without decoupling said digital media player device from said host media presentation device; and
ii) a value of said angle tolerance parameter is at most 45 degrees.

26) The media playback system of claim 25 wherein said value of said rotation tolerance parameter is at most 23 degrees.

27) The media playback system of claim 24 wherein:
i) said digital media player device and said host media presentation device are connected such that a center of said digital media player device cannot be moved by more than a docked device tolerance distance
without decoupling said digital media player device from said host media presentation device;
ii) a value of said docked device tolerance distance is at most a multiple of a maximum dimension of a minimally circumscribing rectangular prism of an inserted plug region of said mated device and host ports; and
iii) a value of said multiple is at most 1.

28) The media playback system of claim 27 wherein said value of said multiple is at most 0.5.

29) The media playback system of claim 27 wherein said value of said multiple is at most 0.25.

30) The media playback system of claim 24 wherein said host presentation device is selected from the group consisting of a TV set, a digital video camcorder, a digital video projector and a home cinema system.

31) A media playback system comprising:
a) a digital media player device including:
i) a digital media player housing; and
ii) a device port mechanically integrated with said digital media player housing;
b) a host media presentation device including:
i) a host device housing; and
ii) a host port mechanically integrated with said host device digital media player housing
c) at least one external connector selected from the group consisting of an external cable and a cradle,
wherein the system is configured such that:
i) said digital media player device is connected to said host device via said device port, said at least one connector and said host port;
ii) said digital media player is operative to effect a playback of stored digital media and to export to said host media presentation device, via said device port, said at least one external connector and said host port
at least one media stream selected from the group consisting of a video stream and an audio stream;
iii) said host port supports the combination of said host media presentation device and said at least one external connector.

32) The media playback system of claim 31 wherein the system is configured such that said host port and said at least one external connector stably maintain an orientation of a docked device vector of the system stable when said docked device vector is substantially perpendicular to gravity vector within a tolerance of 23 degrees.

33) A digital media player device for use with a host media presentation device, the media playback device comprising:
a) a digital media player housing;
b) a digital playback module housed by said housing, said digital playback module operative to effect a media playback of stored digital media to generate at least one of media stream selected from the group consisting of an audio stream and a video stream; and
c) an output plug mechanically integrated with said digital media player housing, said output plug for exporting at least one said media stream to the host media presentation device.

34) The digital media player device of claim 33 wherein a volume ratio between:
i) a minimally circumscribing rectangular prism of the digital media player; and
ii) a minimally circumscribing rectangular prism
of said output plug is at most 10:1.

35) The digital media player device of claim 34 wherein said volume ratio is at most 5:1.

36) The digital media player device of claim 33 wherein said plug is a USB plug.

37) The digital media player device of claim 33 wherein the digital media player device lacks a display screen operative to display played back digital media.

38) The digital media player device of claim 33 wherein the digital media player device lacks a speaker operative to present played back audio media.

39) The digital media player device of claim 33 wherein the digital media player device lacks a camera.

40) The digital media player device of claim 33 wherein the digital media player device lacks a microphone.
